(19) United States
(12) Patent Application Publication
(10) Pub. No.: US 2026/0056514 A1
(43) Pub. Date: Feb. 26, 2026

(54) REDUNDANT CONTROL ARCHITECTURE FOR MULTI-DOMAIN AUTONOMOUS AGENTS

(71) Applicant: Richard Joseph Mitchell, TAVARES, FL (US)

(72) Inventor: Richard Joseph Mitchell, TAVARES, FL (US)

(21) Appl. No.: 19/371,989

(22) Filed: Oct. 28, 2025

(51) Int. Cl. G05B 9/03; B25J 19/06; G05D 1/248; G05D 1/622; G05D 1/698; G05D 1/86; G05D 1/87; G05D 107/00; G05D 107/20; G05D 109/20; G06Q 40/04; G08G 3/02; H04L 9/40

(52) U.S. Cl. CPC G05B 9/03; B25J 19/06; G05D 1/248; G05D 1/622; G05D 1/6983; G05D 1/86; G05D 1/87; G06Q 40/04; H04L 63/1416; G05D 2107/21; G05D 2107/25; G05D 2109/20; G08G 3/02

(57) ABSTRACT

A hybrid, redundant, fail-safe architecture provides a unified fail-operational framework for autonomous agents operating across physical and virtual domains. The system employs a multi-modal data source suite, an adaptive hybrid data fusion module, and an intelligent decision-making module. A novel closed-loop interaction enables a health monitoring module that detects an incipient fault in a data source by monitoring ancillary performance metrics. Upon detection, the module generates a fault signature, including a quantitative prognostic estimate of a future failure time, and transmits it to an adaptive data fusion module. The fusion module proactively reconfigures its state estimation algorithm by decreasing reliance on the degrading data source in proportion to the prognostic estimate. This preemptive compensation ensures the system maintains a high-integrity environmental model and achieves true fail-operational continuity. The architecture is applicable to numerous embodiments providing a universal solution for proactive fault management and system resilience.

### CROSS-REFERENCE TO RELATED APPLICATIONS

This application is related to U.S. patent application titled ‘SYSTEM AND METHOD FOR A UNIFIED, EVIDENTIARY ARTIFICIAL INTELLIGENCE ARCHITECTURE’ and U.S. patent application titled ‘AUTONOMOUS AND COOPERATIVE MULTI-AGENT SYSTEMS FOR PREDICTIVE AND CO-EVOLUTIONARY THREAT MANAGEMENT’. The collection of these inventions constitutes the AURA (Autonomous Unified Reliability Architecture) platform, forming a cohesive patent family.

### BACKGROUND OF THE INVENTION

### 1. Technical Field

The present invention relates generally to the field of autonomous systems. More specifically, it pertains to a unified control and reliability architecture for autonomous agents operating across a wide array of complex physical or virtual environments. This encompasses systems for high-reliability robotics (e.g., surgical, human-collaborative), cyber-physical security, precision agriculture, marine navigation, infrastructure inspection, hazardous material handling, and virtual autonomous software agents.

### 2. Background Art and Limitations

The full potential of autonomous agents, from vehicles to mission-critical software, is limited by the challenge of ensuring robust, reliable, and safe operation in unpredictable environments. A common point of failure is a reliance on siloed, domain-specific solutions that lack a unifying architectural framework for reliability. Conventional systems often employ simple fail-safe mechanisms that halt operations upon fault detection. This reactive approach is often insufficient, economically detrimental, and sometimes even unsafe in a dynamic environment, as the inherent time lag between the onset of data degradation and its detection allows erroneous data to corrupt the system's state estimate.

The operational reliability of autonomous agents is a critical barrier to their widespread adoption. A primary failure point lies in the agent's ability to maintain an accurate understanding of its own state and its environment. Current approaches to fault management are predominantly reactive, often employing fail-safe mechanisms that halt operations upon fault detection. This approach is often insufficient, as the inherent time lag between the onset of data degradation and its detection allows erroneous data to corrupt the system's state estimate.

This fundamental limitation manifests in various domains. For virtual agents (e.g., financial trading bots), reliability critically depends on networked data sources (“virtual sensors”), which are susceptible to insidious failure modes like increased latency, silent data staleness, and API rate-limiting, for which existing fault tolerance is predominantly reactive. In cyber-physical systems, traditional security treats the cyber and physical domains as separate problems, rendering them inadequate for blended cyber-physical attacks.

For resource-constrained autonomous agents (e.g., UAVs), traditional deep learning models introduce high latency, delaying threat detection (e.g., GPS spoofing) until preventative action is no longer possible. In high-stakes environments like surgical robotics, a system fault typically triggers an abrupt stop, which constitutes a secondary hazard when an instrument is near sensitive tissue. In Human-Robot Collaboration (HRC), safety protocols default to reactive stops, compromising efficiency.

Furthermore, regulatory and ethical complexity presents challenges. For Autonomous Surface Vessels (ASVs), compliance with the International Regulations for Preventing Collisions at Sea (COLREGs) is difficult to codify into deterministic algorithms. Separately, autonomous vehicles dealing with multiple simultaneous threats lack a unified, ethical framework to prioritize action based on a hierarchy of vulnerability (e.g., human vs. animal vs. property).

The common, fundamental need across all these domains is a system that moves beyond reactive, domain-specific fault responses to a proactive, anticipatory paradigm that can ensure fail-operational continuity regardless of the agent's specific mission or environment.

### BRIEF SUMMARY OF THE INVENTION

The present invention provides a hybrid, redundant, fail-safe architecture that serves as a unified fail-operational framework for autonomous agents. The system comprises a health monitoring module that detects incipient faults in system components, such as physical or virtual data sources, by monitoring ancillary performance metrics. An incipient fault is a statistically significant degradation that precedes a complete failure.

Upon detecting an incipient fault, the health monitoring module generates a structured fault signature, which includes a quantitative prognostic estimate of a future failure time or Remaining Useful Life (RUL). This signature is transmitted to an adaptive data fusion module, which utilizes a Kalman-type estimator. In response, the fusion module proactively reconfigures its algorithm, for example by inflating a measurement-noise covariance matrix associated with the degrading data source. The magnitude of this inflation is a function of the prognostic estimate.

This proactive compensation preemptively reduces the system's reliance on the degrading data source before its output corrupts the agent's state estimate, thereby ensuring fail-operational continuity. The architecture is disclosed in connection with numerous distinct embodiments, including virtual software agents, cyber-physical security systems, autonomous marine vessels, high-reliability robotics, and environmental conservation drones, providing a universal solution for proactive fault management and system resilience.

### BRIEF DESCRIPTION OF THE SEVERAL VIEWS OF THE DRAWING

FIG. 1 is a block diagram illustrating the overall architecture of the system.

FIG. 2 is a block diagram illustrating the adaptive hybrid sensor fusion module.

FIG. 3 is a block diagram illustrating the redundant processing and control architecture, including the novel communication pathway between the Health Monitoring and Fault Management Module and the Adaptive Hybrid Sensor Fusion Module.

FIG. 4 is an exemplary illustration of the system embodied on an Unmanned Aerial Vehicle (UAV) adapted for agricultural or conservation tasks.

FIG. 5 is an exemplary illustration of the system embodied on an Autonomous Ground Vehicle (AGV) adapted for agricultural tasks.

FIG. 6 is an exemplary illustration of the system embodied on an Autonomous Ground Vehicle (AGV) adapted for inspecting infrastructure like pipelines or bridge supports.

FIG. 7 is an exemplary illustration of the system embodied on an Autonomous Marine Vessel (AMV).

FIG. 8 is an exemplary illustration of the system embodied on a Space Rover.

FIG. 9 is an exemplary illustration of the system embodied on an industrial robot platform suitable for collaborative or hazardous material handling tasks.

FIG. 10 is a block diagram illustrating the system architecture for the Autonomous Cyber-Physical System Security embodiment.

FIG. 11 is a block diagram detailing the implementation of a quantum-secure communication channel using a Quantum Key Distribution (QKD) protocol.

FIG. 12 is a block diagram illustrating the architecture of a Spiking Neural Network (SNN) within a neuromorphic computing module for low-latency anomaly detection.

FIG. 13 is a block diagram illustrating the components of the immutable audit log system.

### DETAILED DESCRIPTION OF THE INVENTION

### System Architecture and Core Components (General Embodiment)

The Hybrid, Redundant, Fail-Safe Architecture (HRFSA) provides a foundational and fail-operational framework for commanding a plurality of autonomous agents. These agents are broadly defined to encompass both physical embodiments (e.g., UAVs, AGVs, AMVs, rovers as shown in FIGS. 4-9) and virtual embodiments (e.g., autonomous software agents).

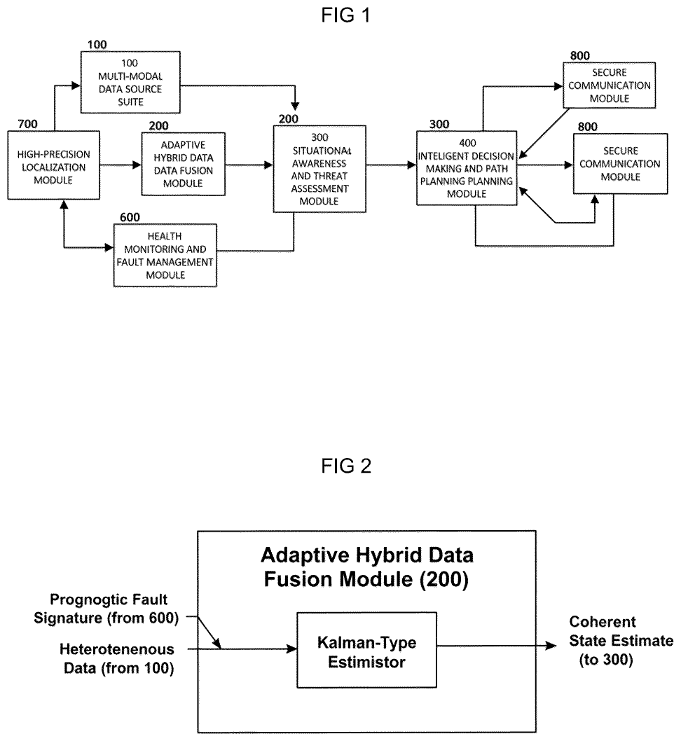

Referring to FIG. 1, the HRFSA comprises several interconnected, high-performance modules: a Multi-Modal Data Source Suite (100) for gathering heterogeneous data; an Adaptive Hybrid Data Fusion Module (200) for processing raw data into a coherent environmental model; a Situational Awareness and Threat Assessment Module (300) for interpreting the fused data; an Intelligent Decision-Making and Path Planning Module (400) for generating optimal and safe action plans; a Redundant Control and Actuation Module (500) for executing planned actions; a Health Monitoring and Fault Management Module (600) for continuously assessing system health; a High-Precision Localization Module (700) for positioning; and a Secure Communication Module (800) for data exchange.

### The Central Inventive Concept: Proactive Fault Compensation

The core innovation is a synergistic, closed-loop interaction between the Health Monitoring Module (600) and the Adaptive Hybrid Data Fusion Module (200), moving the system beyond reactive mechanisms.

The Health Monitoring Module (600) is configured to detect an incipient fault, defined as a detectable, statistically significant degradation in a data source's performance metrics that is a known precursor to a complete failure. For physical sensors, this includes parameters like current draw or vibration. For virtual sensors (APIs), this includes data latency, data schema integrity, and update frequency. Detection is accomplished by applying a Statistical Process Control (SPC) algorithm.

Upon detection, the module (600) generates a structured fault signature. This data packet contains an identifier for the degrading data source, a fault type, a quantitative confidence score, and a prognostic estimate such as an Estimated Time-to-Failure (τ) or Remaining Useful Life (RUL).

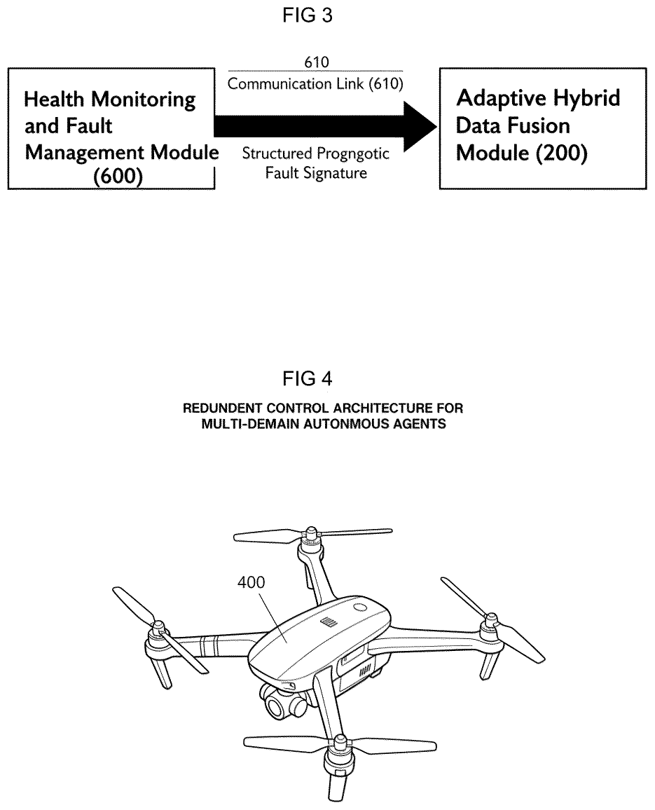

As shown in FIG. 3, this signature is transmitted via a link (610) to the Adaptive Hybrid Data Fusion Module (200). Referring to FIG. 2, the fusion module (200) utilizes a Kalman-type estimator, which is defined herein to include the linear Kalman filter and its common non-linear variants such as the Extended Kalman Filter (EKF) and the Unscented Kalman Filter (UKF). The module (200) proactively inflates the measurement-noise covariance matrix (Rₖ) associated with the degrading sensor. The magnitude of this inflation is an inverse function of the prognostic estimate, ensuring a smooth, graceful, and proportional compensation. For example, the new covariance R_{k,new} can be calculated as R_{k,new}=R_{k,initial}×(1+α·e^{-β·RUL}), where α and β are tunable parameters. This action reduces the Kalman Gain (Kₖ), thereby de-weighting the degrading data source before its output becomes erroneous.

### Advanced AI Control Methodologies (Module 400 Implementations)

The Intelligent Decision-Making and Path Planning Module (400) utilizes the health-informed state estimate to generate trajectories. This can be implemented via several advanced AI methodologies. In a Reinforcement Learning (RL) implementation, the decision-making problem is modeled as a Markov Decision Process (MDP), and the multi-objective reward function includes a novel health preservation objective (Rₕₑₐₗₜₕ) that penalizes actions inducing high stress on components with a low RUL. In a Model Predictive Control (MPC) implementation, the optimization is subject to dynamic, health-informed constraints that are adjusted in real-time based on the prognostic RUL of the corresponding component. In a Graph Optimization implementation, an A* search algorithm is employed where the cost assigned to each edge includes a predicted health degradation cost (Cₕₑₐₗₜₕ).

### SPECIALIZED EMBODIMENTS AND APPLICATIONS

### Virtual Autonomous Agents

For a virtual agent, such as an automated financial trading bot, external data feeds (APIs) are treated as “virtual sensors.” Ancillary performance metrics include API latency, data schema integrity, and update frequency. A statistically significant increase in API latency, detected by the Health Monitoring Module (600), can be used to generate an RUL for that data feed. This RUL would then proactively inflate the measurement-noise covariance matrix in a Kalman filter used for price tracking, reducing reliance on the latent (and therefore stale) data source before it can trigger erroneous trades.

### Cyber-Physical Systems and Cyber-Resilience

Referring to FIG. 10, the system detects a blended attack by identifying a statistical correlation between a digital anomaly (e.g., increased processor load on a control device) and a physical anomaly. A Graph Neural Network (GNN) is used to learn these joint feature embeddings. A Coordinated Response Module (150), which is a functional component of the Intelligent Decision-Making Module (400), selects an optimal pair of cyber and physical fail-operational responses based on a real-time operational impact assessment.

### Low-Latency Anomaly Detection (Neuromorphic Computing)

Referring to FIG. 12, for an agent requiring microsecond-level threat response, such as detecting GPS spoofing, a neuromorphic computing unit uses a derivative event encoding scheme to convert sensor data into spike trains. This scheme emits a spike only when the discrete-time difference of the sensor value exceeds a predetermined threshold, employing hysteresis to filter noise. A Spiking Neural Network (SNN) trained with unsupervised Spike-Timing-Dependent Plasticity (STDP) learns normal spatiotemporal patterns. An anomalous pattern triggers an immediate hardware interrupt to the flight controller.

### Quantum-Secure Communication

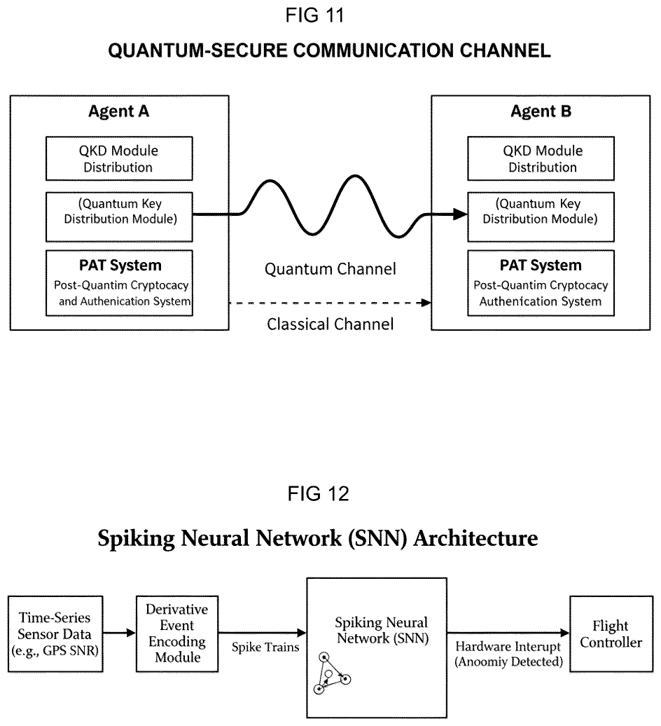

Referring to FIG. 11, for a swarm of agents communicating via a Quantum Key Distribution (QKD) network, the physical layer security metrics of the QKD link (e.g., Quantum Bit Error Rate (QBER), Pointing, Acquisition, and Tracking (PAT) errors) serve as ancillary health metrics. These local metrics are aggregated using Geometric Median Consensus (GMC) to form a robust Global Swarm Security Posture Metric (G-SSPM). This metric is used as a direct, real-time state input to a Multi-Agent Reinforcement Learning (MARL) control policy, which in turn commands a coordinated physical maneuver of the swarm to improve the health of the QKD links.

### Robotics (Surgical & HRC) and Graceful Degradation

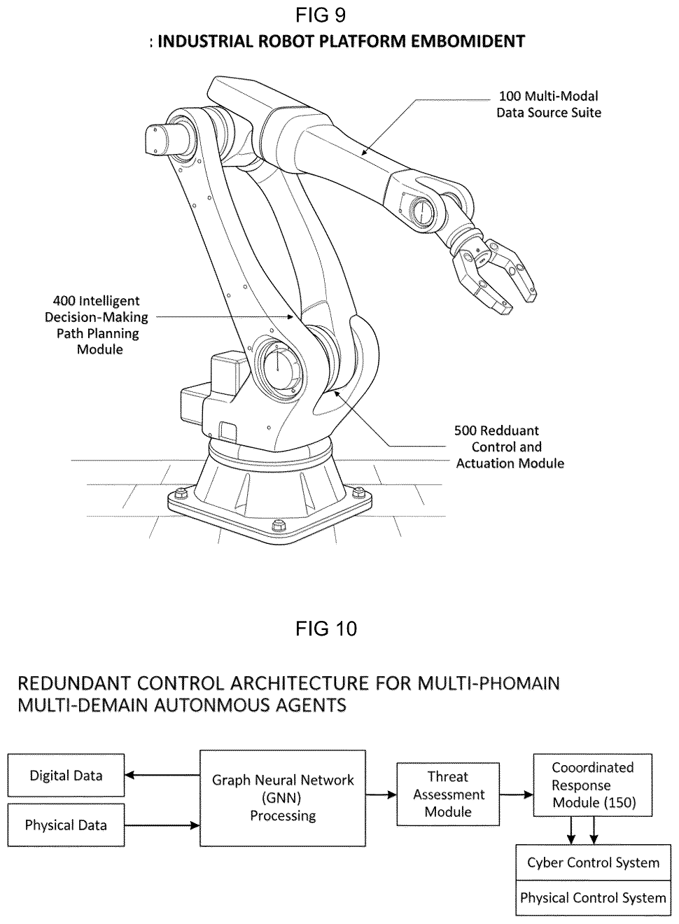

For a surgical robot (FIG. 9), a prognostic fault signature triggers context-aware fail-safe protocols such as automatic instrument retraction along a known-safe path or precise force limiting. For Human-Robot Collaboration (HRC), the system uses AI to predict human motion and proactively adapt the robot's speed and path, backed by a secondary fail-safe layer of redundant force/torque sensors.

### Autonomous Environmental and Wildlife Conservation

For a conservation drone (FIG. 4), detection of camouflaged animals is based on a two-stage process: first, a geometric validation of a LIDAR 3D point cloud against a stored 3D morphological template, and second, a cross-modal correlation of the validated shape with a spatially co-located thermal signature. The PHM module uses RUL estimates to autonomously modify mission parameters, such as altering a flight path to reduce stress on a degrading motor.

### Autonomous Marine Vessels

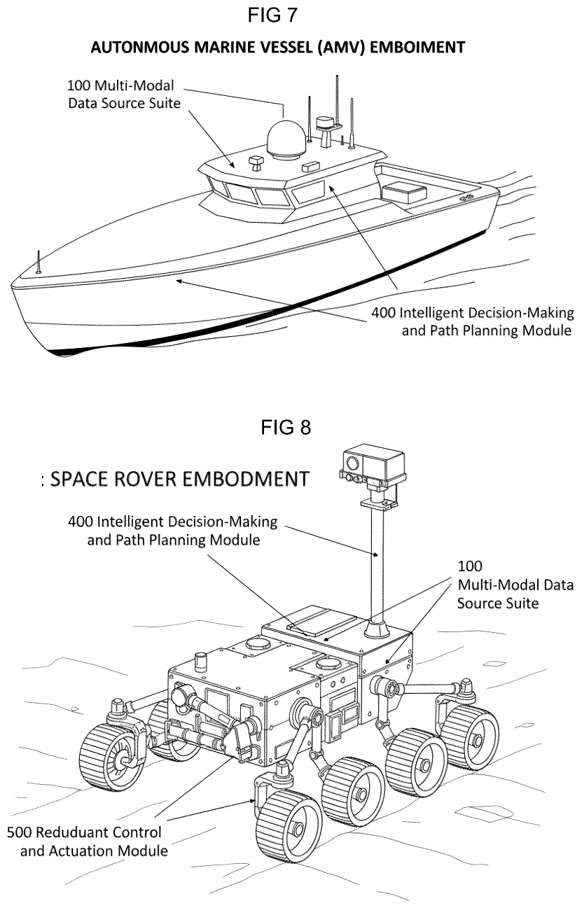

For an AMV (FIG. 7), COLREGs rules are translated into hard mathematical constraints within an MPC optimization problem. The system utilizes the state covariance matrix (P) from a health-informed Kalman filter to define an uncertainty tube around the predicted trajectory and tightens the constraints to ensure the entire tube remains compliant, making the maneuver robust and certifiable.

### Infrastructure Inspection and Maintenance

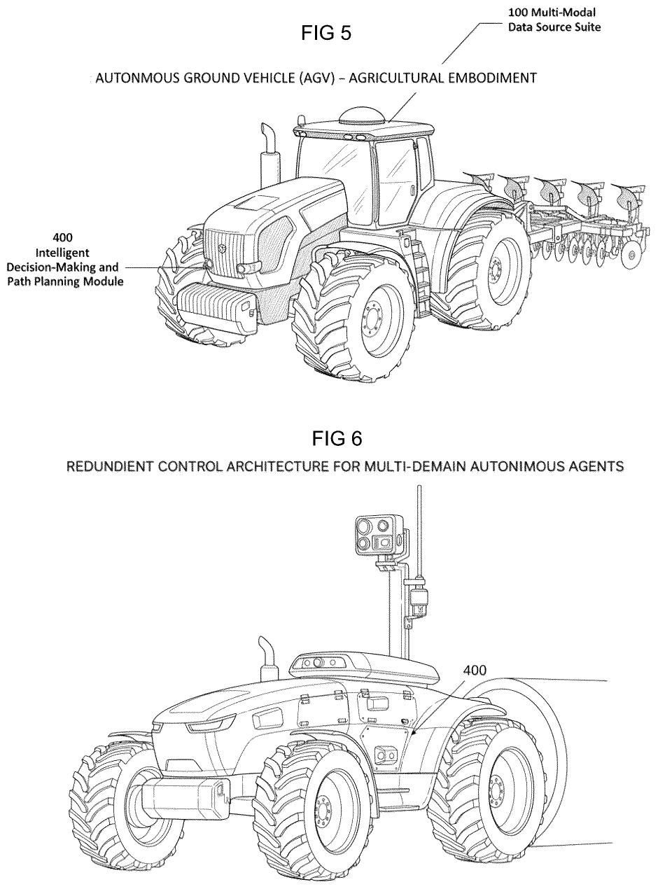

For an inspection vehicle (FIG. 6), a fault detection triggers the generation of an optimal path to a safe recovery zone by solving a multi-objective optimization problem. The cost function includes a predicted health degradation cost (based on RUL) and a public safety risk cost, balancing mission survival with public safety.

### Hazardous Materials Handling

For a robot handling hazardous materials (FIG. 9), a prognostic fault signature for a primary manipulator triggers a coordinated handover to a redundant manipulator using a load-balancing algorithm. If a fault requires moving to a safe zone, a path is generated by solving a multi-objective optimization problem that balances the robot's degrading health against the risk of a hazardous material breach.

### Immutable Audit Log

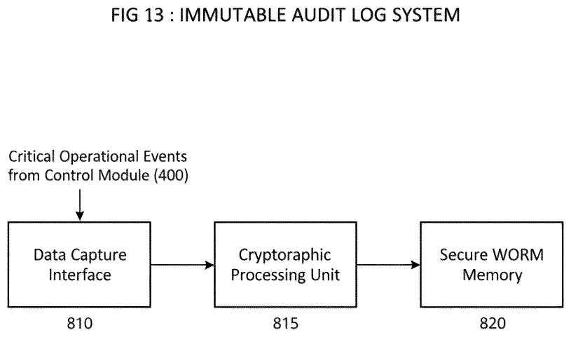

Referring to FIG. 13, a Cryptographic Processing Unit (815) within the Secure Communication Module (800) creates a cryptographically secure audit trail. For each critical event, a log entry is created that includes the hash of the preceding entry, forming a hash chain. The entry is digitally signed and stored in a Secure Write-Once, Read-Many (WORM) Memory Component (820), ensuring an unmodifiable record for regulatory compliance.

What is claimed is:

1. A system for providing fail-operational control of an autonomous agent, comprising:
a. a multi-modal data source suite configured to acquire heterogeneous data from an operational environment, the suite comprising a first data source and a second, different data source;
b. an adaptive hybrid data fusion module communicatively coupled to the multi-modal data source suite, configured to process said heterogeneous data into a coherent state estimate using a Kalman-type estimator, wherein the Kalman-type estimator is a linear Kalman filter or a non-linear variant thereof;
c. a prognostics and health management module communicatively coupled to the multi-modal data source suite and the adaptive hybrid data fusion module, configured to:
i. continuously monitor a health status of the first data source by measuring at least one performance metric distinct from the data acquired for state estimation;
ii. upon detecting an incipient fault in the first data source, wherein the incipient fault is a statistically significant degradation in said performance metric prior to a complete failure, generate a structured prognostic fault signature comprising at least a quantitative prognostic estimate of a future failure time of the first data source; and
iii. transmit said structured prognostic fault signature to the adaptive hybrid data fusion module to cause said fusion module to proactively reconfigure the Kalman-type estimator by inflating a measurement-noise covariance matrix (Rx) associated with the first data source, wherein a magnitude of said inflation is a function of the quantitative prognostic estimate, thereby preemptively compensating for data degradation from the incipient fault before said degradation corrupts the state estimate.

2. The system of claim 1, wherein the quantitative prognostic estimate is a Remaining Useful Life (RUL) or an Estimated Time-to-Failure (τ).

3. The system of claim 2, wherein the structured prognostic fault signature further comprises a confidence score indicating a probability that the incipient fault is a true fault, and wherein the magnitude of the inflation of the measurement-noise covariance matrix is a function of both the confidence score and the RUL or τ.

4. The system of claim 1, wherein the prognostics and health management module is configured to detect the incipient fault by applying a Statistical Process Control (SPC) algorithm to the at least one performance metric.

5. The system of claim 4, wherein the SPC algorithm is a Cumulative Sum (CUSUM) test or an Exponentially Weighted Moving Average (EWMA) control chart.

6. The system of claim 1, wherein the autonomous agent is a physical autonomous vehicle, the first data source is a first physical sensor, and the at least one performance metric is selected from the group consisting of current draw, operating temperature, and a vibration signature.

7. The system of claim 1, wherein the inflation of the measurement-noise covariance matrix (Rₖ) automatically reduces a Kalman Gain (Kₖ) associated with the first data source, thereby reducing a weight placed on data from the first data source in the coherent state estimate.

8. A method for providing fail-operational control of an autonomous agent, the method comprising:
a. acquiring, via a multi-modal data source suite comprising a first data source and a second, different data source, heterogeneous data from an operational environment;
b. processing, via an adaptive hybrid data fusion module, the heterogeneous data into a coherent state estimate using a Kalman-type estimator, wherein the Kalman-type estimator is a linear Kalman filter or a non-linear variant thereof;
c. continuously monitoring, via a prognostics and health management module, a health status of the first data source by measuring at least one performance metric distinct from the data acquired for state estimation;
d. upon detecting an incipient fault in the first data source, wherein the incipient fault is a quantified deviation from a baseline of the performance metric that exceeds a predetermined statistical threshold prior to a complete failure, generating, via the prognostics and health management module, a structured prognostic fault signature comprising at least a quantitative prognostic estimate of a Remaining Useful Life (RUL) of the first data source;
e. transmitting the structured prognostic fault signature to the adaptive hybrid data fusion module; and
f. in response to receiving the structured prognostic fault signature, proactively reconfiguring, during ongoing operation, the Kalman-type estimator by inflating a measurement-noise covariance matrix (Rₖ) associated with the first data source, wherein a magnitude of said inflation is proportional to a degradation indicated by the RUL, thereby preemptively compensating for data degradation.

9. The method of claim 8, wherein the structured prognostic fault signature further comprises a confidence score, and wherein the magnitude of the inflation is a function of both the confidence score and the RUL.

10. The method of claim 8, wherein the autonomous agent is a physical autonomous vehicle, and at least one performance metric is selected from the group consisting of current draw, operating temperature, and a vibration signature.

11. A cyber-resilient system for protecting a cyber-physical critical infrastructure, the system comprising:
a. a processor; and
b. a memory storing instructions that, when executed by the processor, configure the system to:
i.
i. receive heterogeneous digital data from a plurality of digital sensors monitoring a computer network of the critical infrastructure and heterogeneous physical data from a plurality of physical sensors monitoring a physical state of the critical infrastructure;
ii.
ii. construct a heterogeneous cross-domain graph data structure, wherein nodes in the graph represent cyber and physical components of the critical infrastructure and wherein typed, directed edges in the graph represent functional dependencies between said components;
ii
iii. process the heterogeneous cross-domain graph using a graph attention network to learn joint feature embeddings that capture weighted non-linear dependencies between the digital data and the physical data by assigning attention scores to different neighboring nodes based on node and edge types;
iv.
iv. input the joint feature embeddings into a threat assessment module to classify a blended cyber-physical attack and determine a threat confidence score; and
v. in response to classifying the blended cyber-physical attack with the threat confidence score exceeding a predetermined threshold, select, via a coordinated response module, an optimal pair of a cyber fail-operational response and a physical fail-operational response from a predefined library of response pairs based on a real-time operational impact assessment that predicts cascading operational effects of each response pair, and transmit a first command to a network control system to execute the selected cyber fail-operational response and a second command to a physical control system to execute the selected physical fail-operational response.

12. The system of claim 11, wherein the plurality of digital sensors includes at least two selected from the group consisting of a network traffic analyzer, a firewall log, an endpoint detection and response (EDR) alert, an identity and access management (IAM) log, and a Supervisory Control and Data Acquisition (SCADA) process data stream.

13. The system of claim 11, wherein the plurality of physical sensors includes at least two selected from the group consisting of an inertial measurement unit (IMU), an actuator position feedback sensor, a thermal sensor, an acoustic sensor, a voltage sensor, and a current sensor.

14. The system of claim 11, wherein the typed, directed edges include a controls edge type representing a direct control relationship from a cyber component to a physical component.

15. The system of claim 11, wherein the real-time operational impact assessment predicts at least one of system downtime, potential for cascading failures, or a change in a safety integrity level for each response pair in the predefined library by executing a forward simulation based on a dynamic model of the critical infrastructure.

16. The system of claim 11, wherein the selected cyber fail-operational response comprises at least one of re-routing network traffic to bypass a compromised component or isolating the compromised component in a virtual local area network (VLAN).

17. The system of claim 11, wherein the selected physical fail-operational response comprises at least one of disengaging a compromised physical component or activating a redundant physical component to assume the function of the compromised physical component.

18. A method for providing cyber-resilience to a cyber-physical critical infrastructure, the method comprising:
a. receiving, via a processor, heterogeneous digital data from a plurality of digital sensors and heterogeneous physical data from a plurality of physical sensors;
b. constructing, via the processor, a heterogeneous cross-domain graph data structure, wherein nodes in the graph represent cyber and physical components and typed, directed edges represent functional dependencies between the components;
c. processing, via the processor, the heterogeneous cross-domain graph using a graph attention network to learn joint feature embeddings that capture weighted non-linear dependencies by assigning attention scores to different neighboring nodes based on node and edge types;
d. inputting, via the processor, the joint feature embeddings into a threat assessment module to classify a blended cyber-physical attack and determine a threat confidence score; and
e. in response to classifying the blended cyber-physical attack with the threat confidence score exceeding a predetermined threshold, selecting an optimal pair of a cyber fail-operational response and a physical fail-operational response from a predefined library based on a real-time operational impact assessment that predicts cascading operational effects, and transmitting a first command to execute the selected cyber fail-operational response and a second command to execute the selected physical fail-operational response.

19. The method of claim 18, wherein the real-time operational impact assessment predicts at least one of system downtime or a change in a safety integrity level for each response pair in the predefined library.

20. The method of claim 18, wherein the first and second commands are transmitted near-simultaneously to ensure a synchronized response.

21. A system for low-latency anomaly detection in an autonomous agent, comprising:
a. a Global Positioning System (GPS) receiver configured to acquire time-series signal-to-noise ratio (SNR) data from a plurality of satellite channels; and
b. a neuromorphic computing unit communicatively coupled to the GPS receiver, the neuromorphic computing unit comprising:
i. an input encoding module configured to convert the time-series SNR data into a plurality of spike trains using a derivative event encoding scheme that emits a spike only when a discrete-time difference of the SNR data exceeds a predetermined threshold, wherein the module is further configured to employ a hysteresis value to inhibit spurious spikes near the threshold; and
ii. a spiking neural network (SNN) comprising leaky integrate-and-fire (LIF) neurons, the SNN having an input layer, at least one hidden layer, and an output neuron, the SNN configured to:
receive the plurality of spike trains at the input layer;
process the plurality of spike trains through the at least one hidden layer, wherein the at least one hidden layer is trained using unsupervised spike-timing-dependent plasticity (STDP) on authentic time-series data to learn normal spatiotemporal patterns corresponding to the sparse and asynchronous stream of spike trains; and
cause the output neuron to assert a hardware interrupt to a flight controller upon detecting an anomalous spatiotemporal pattern indicative of a GPS spoofing attack that deviates from the normal spatiotemporal patterns.

22. The system of claim 21, wherein the autonomous agent is an unmanned aerial vehicle (UAV), and the neuromorphic computing unit is an embedded hardware device configured for low-power operation on the UAV.

23. The system of claim 21, wherein the flight controller comprises logic configured to, in response to the hardware interrupt, reject a GPS-derived position solution and transition to an inertial backup navigation mode.

24. The system of claim 21, wherein the predetermined threshold and the hysteresis value are empirically determined by processing a calibration dataset of authentic SNR data to achieve a baseline spike rate below a specified limit.

25. A method for low-latency anomaly detection in an autonomous agent, comprising:
a. acquiring, via a Global Positioning System (GPS) receiver on the autonomous agent, time-series signal-to-noise ratio (SNR) data from a plurality of satellite channels;
b. generating, via an input encoding module, a plurality of spike trains by converting the time-series SNR data using a derivative event encoding scheme, wherein a spike is emitted only when a discrete-time difference of the SNR data exceeds a predetermined threshold, and wherein a hysteresis value is employed to inhibit spurious spikes near the threshold, said generating producing a sparse and asynchronous stream of spike trains during periods of authentic time-series data, thereby enabling a downstream neuromorphic computing unit to operate in a low-power state;
c. processing, via a spiking neural network (SNN) comprising leaky integrate-and-fire (LIF) neurons implemented on the neuromorphic computing unit, the plurality of spike trains to identify deviations from a learned set of normal spatiotemporal patterns corresponding to authentic time-series data, wherein the SNN is trained using unsupervised spike-timing-dependent plasticity (STDP); and
d. generating a hardware interrupt to a flight controller when an anomalous spatiotemporal pattern indicative of a GPS spoofing attack is identified.

26. The method of claim 25, further comprising, in response to the hardware interrupt, causing the flight controller to reject a GPS position solution and transition to a backup navigation mode.

27. The method of claim 25, wherein processing the plurality of spike trains is performed with a detection latency of less than 1 millisecond.

28. A system for security-aware maneuvering of a multi-agent autonomous swarm, comprising:
a. a plurality of mobile autonomous agents forming a swarm, each agent comprising an intelligent decision-making module configured for distributed control;
b. a Quantum Key Distribution (QKD) system configured to establish a hybrid quantum-classical mesh network between the plurality of mobile autonomous agents, wherein the network includes free-space optical quantum channels;
c. QKD modules and Pointing, Acquisition, and Tracking (PAT) systems disposed on the agents, configured to generate a plurality of local operational parameters indicative of a status and integrity of the quantum links, said parameters including at least a Quantum Bit Error Rate (QBER) and a PAT error signal;
d. a distributed processor configured to:
i. receive the local operational parameters from the plurality of mobile autonomous agents, wherein the local operational parameters are formulated as normalized vectors;
ii. execute a robust state update model utilizing an iterative approximation algorithm to calculate a geometric median consensus of the normalized vectors, said consensus being robust to outlier data from a Byzantine adversary; and
iii. generate a Global Swarm Security Posture Metric (G-SSPM) based on the calculated geometric median consensus;
wherein the intelligent decision-making module is configured to execute a Multi-Agent Reinforcement Learning (MARL) control policy that utilizes the G-SSPM as a real-time state input to generate a coordinated joint action plan for the plurality of mobile autonomous agents in response to the G-SSPM crossing a predetermined response threshold.

29. The system of claim 28, wherein the iterative approximation algorithm is a modified Weiszfeld's algorithm.

30. The system of claim 28, wherein the MARL control policy utilizes a reward function comprising a security penalty term that is an exponential function of a degradation in the G-SSPM relative to a critical security threshold, thereby training the policy to prioritize actions that improve the G-SSPM.

31. The system of claim 28, wherein the coordinated joint action plan comprises a coordinated physical maneuver commanding the plurality of mobile autonomous agents to alter a collective formation geometry to optimize optical alignment of the free-space optical quantum channels and reduce the PAT error signals across the swarm.

32. The system of claim 28, wherein the QKD system is configured to operate in a dynamic multi-hop trusted node topology, and wherein the coordinated joint action plan includes repositioning a subset of agents to optimize the multi-hop trusted node topology to bypass obstructions or interference.

33. A method for providing integrated quantum-secure communication and cyber-physical defense for a multi-agent autonomous swarm, the method comprising:
a. establishing a hybrid quantum-classical mesh network between a plurality of mobile autonomous agents, the network including free-space optical quantum channels maintained by Pointing, Acquisition, and Tracking (PAT) systems;
b. calculating a plurality of local operational parameters, including at least a Quantum Bit Error Rate (QBER) and a PAT error signal, for active quantum links in the network;
c. formulating the plurality of local operational parameters as normalized vectors;
d. aggregating the normalized vectors using a distributed processor executing a robust state update model, wherein the robust state update model comprises an iterative approximation algorithm to calculate a geometric median consensus of the normalized vectors, said consensus being robust to outlier data from a Byzantine adversary;
e. generating a Global Swarm Security Posture Metric (G-SSPM) based on the calculated geometric median consensus;
f. utilizing the G-SSPM as a real-time state input in a Multi-Agent Reinforcement Learning (MARL) control policy; and
g. in response to the G-SSPM exceeding a predetermined response threshold, autonomously commanding a coordinated physical maneuver of the plurality of mobile autonomous agents to improve the G-SSPM.

34. The method of claim 33, wherein the MARL control policy is implemented using a Centralized Training, Decentralized Execution (CTDE) architecture.

35. The method of claim 33, further comprising applying a reward function for the MARL control policy that includes a security penalty term defined as an exponential function of a degradation in the G-SSPM, thereby prioritizing restoration of information-theoretic security over other mission objectives.

36. The method of claim 33, wherein the coordinated physical maneuver comprises altering the collective formation geometry of the plurality of agents to optimize optical alignment of the free-space optical quantum channels.

37. A system for providing fail-operational control of a virtual autonomous agent, the system comprising:
a. a virtual sensor suite comprising a first data source and a second, different data source, the suite configured to acquire heterogeneous data from a virtual operational environment of the agent, wherein said data sources are Application Programming Interfaces (APIs) or network data streams;
b. a health monitoring module communicatively coupled to the virtual sensor suite and configured by computer-executable instructions to:
i. continuously monitor a health status of the first data source by measuring at least one performance metric specific to a networked data source, said metric selected from the group consisting of data latency, data schema integrity, and update frequency;
ii. upon detecting an incipient fault in the first data source, wherein the incipient fault is a statistically significant degradation in said performance metric prior to a complete failure of the first data source, generate a structured fault signature corresponding to the first data source, wherein the structured fault signature is a data packet comprising a data source identifier, a fault type classification, and a confidence score indicating a probability that the incipient fault is a true fault;
c. an adaptive virtual data fusion module communicatively coupled to the virtual sensor suite and the health monitoring module, the fusion module configured by computer-executable instructions to:
i. process said heterogeneous data from the virtual sensor suite into a coherent model of the virtual environment using a data aggregation algorithm comprising a Kalman filter; and
ii. upon receiving said structured fault signature, proactively reconfigure the data aggregation algorithm by modifying a measurement-noise covariance matrix of the Kalman filter associated with the first data source, wherein said modification is proportional to the confidence score, thereby preemptively compensating for data degradation from the incipient fault while continuing to utilize data from the first data source.

38. The system of claim 37, wherein the virtual autonomous agent is an automated financial trading agent.

39. The system of claim 37, wherein the first and second data sources are real-time financial data APIs providing stock information, and wherein the proactive reconfiguration of the data aggregation algorithm reduces trade execution slippage caused by data latency from the first data source.

40. The system of claim 37, wherein the virtual autonomous agent is a network security agent.

41. The system of claim 40, wherein the first and second data sources are external threat intelligence feeds, and wherein the fault type classification is ‘stale_data’.

42. The system of claim 37, further comprising a virtual actuation module comprising a plurality of APIs for executing actions in the virtual environment based on the coherent model produced by the reconfigured data aggregation algorithm.

43. A method for providing fail-operational control of a virtual autonomous agent, the method comprising:
a. acquiring, via a virtual sensor suite comprising a first data source and a second, different data source, heterogeneous data from a virtual operational environment, wherein said data sources are Application Programming Interfaces (APIs) or network data streams;
b. continuously monitoring, via a health monitoring module, a health status of the first data source by measuring at least one performance metric specific to a networked data source, said metric selected from the group consisting of data latency, data schema integrity, and update frequency;
c. upon detecting an incipient fault in the first data source, wherein the incipient fault is a quantified deviation from a baseline of the performance metric that exceeds a predetermined statistical threshold prior to a complete failure, generating, via the health monitoring module, a structured fault signature comprising a data source identifier, a fault type classification, and a confidence score indicating a probability that the incipient fault is a true fault;
d. transmitting the structured fault signature to an adaptive virtual data fusion module;
e. processing, via the adaptive virtual data fusion module, the heterogeneous data using a data aggregation algorithm that assigns adjustable weights to the first and second data sources; and
f. in response to receiving the structured fault signature, reconfiguring during ongoing operation the data aggregation algorithm by smoothly and dynamically decreasing a weight assigned to the first data source in proportion to the confidence score while correspondingly increasing a weight assigned to the second data source, thereby preemptively compensating for data degradation while continuing to utilize data from the first data source.

44. The method of claim 43, wherein the virtual autonomous agent is an automated financial trading agent and the data sources are real-time financial data feeds.

45. The method of claim 43, wherein at least one performance metric is data latency, and the incipient fault is a statistically significant increase in said data latency.

46. A system for providing fail-operational control of an autonomous precision agriculture vehicle, comprising:
a. a multi-modal sensor suite configured on the vehicle, the suite comprising at least one specialized agricultural sensor and at least one navigational sensor;
b. a health monitoring and fault management module communicatively coupled to the multi-modal sensor suite and configured to:
i. continuously monitor a health status of the at least one specialized agricultural sensor by applying a statistical process control (SPC) algorithm to a performance metric of said sensor; and
ii. upon detecting an incipient fault, wherein said incipient fault is defined as a deviation of the performance metric from a pre-established statistical control limit, generate a fault signature corresponding to the agricultural sensor and an anticipated failure mode thereof;
c. an adaptive hybrid sensor fusion module communicatively coupled to the multi-modal sensor suite and the health monitoring module, configured to:
i. process data from the sensor suite into a coherent model of an agricultural environment; and
ii. upon receiving said fault signature, proactively reconfigure a fusion algorithm by decreasing a weight assigned to data from the at least one specialized agricultural sensor exhibiting the incipient fault and increasing a weight assigned to data from a historical data source, thereby enabling the vehicle to continue an agricultural task.

47. The system of claim 46, wherein the autonomous precision agriculture vehicle is an autonomous tractor or an unmanned aerial vehicle.

48. The system of claim 46, wherein the at least one specialized agricultural sensor is a hyperspectral camera configured to assess crop health.

49. The system of claim 46, wherein the at least one specialized agricultural sensor is a real-time soil sensor configured to measure soil properties.

50. The system of claim 46, wherein the historical data source is a historical yield map of the agricultural environment.

51. The system of claim 46, further comprising a situational awareness module configured to detect a human within a predefined safety zone around the vehicle, and wherein upon detection of said human, the system is configured to initiate a fail-safe protocol comprising a controlled stop of the vehicle.

52. A method for providing fail-operational control of an autonomous precision agriculture vehicle, the method comprising:
a. acquiring, via a multi-modal sensor suite on the vehicle, data pertinent to an agricultural environment, said data including data from at least one specialized agricultural sensor;
b. continuously monitoring, via a health monitoring module, a health status of the at least one specialized agricultural sensor by applying a statistical process control (SPC) algorithm to a performance metric of said sensor to detect an incipient fault;
c. upon detecting the incipient fault, generating, via the health monitoring module, a fault signature corresponding to the agricultural sensor;
d. transmitting the fault signature to an adaptive hybrid sensor fusion module; and
e. in response to receiving the fault signature, proactively reconfiguring, via the adaptive hybrid sensor fusion module, a data fusion algorithm by decreasing a weight assigned to data from the agricultural sensor exhibiting the incipient fault and increasing a weight assigned to data from a historical data source, thereby allowing the vehicle to continue performing an agricultural task.

53. The method of claim 52, wherein the historical data source is a historical yield map of the agricultural environment.

54. The method of claim 52, further comprising:
a. continuously monitoring, via the sensor suite, a predefined safety zone around the vehicle for the presence of a human; and
b. initiating a fail-safe protocol comprising a controlled stop of the vehicle upon detection of a human within the safety zone.

55. A fail-operational control and navigation system for an autonomous marine vessel, the system comprising:
a. a multi-modal sensor suite configured on the vessel, the suite comprising a plurality of marine-specific sensors for acquiring data from a marine environment, wherein the plurality of sensors includes a first sensor and a second sensor;
b. a health monitoring and fault management module comprising a processor configured to execute instructions to:
i. continuously monitor a set of operational parameters of the first sensor, said parameters being distinct from data primarily used for navigation;
ii. detect an incipient fault based on a statistically significant deviation of said operational parameters from a nominal baseline, said incipient fault being indicative of a future functional failure of the first sensor; and
iii. upon detecting the incipient fault, generate a predictive fault signature encoding a quantitative measure of a severity of the incipient fault;
c. an adaptive hybrid sensor fusion module communicatively coupled to the health monitoring and fault management module, the adaptive hybrid sensor fusion module configured to:
i. process data from the sensor suite using a state estimation filter to generate a vessel state estimate and a state covariance matrix (P) representing an uncertainty of the vessel state estimate; and
ii. upon receiving said predictive fault signature, proactively reconfigure the state estimation filter by decreasing a weight assigned to data from the first sensor, wherein said reconfiguration increases the uncertainty represented by the state covariance matrix (P); and
d. an intelligent decision-making module configured to generate a navigational plan in compliance with the International Regulations for Preventing Collisions at Sea (COLREGs) by:
i. translating a rule from the COLREGs into a hard mathematical constraint on a predicted state trajectory of the vessel within a Model Predictive Control (MPC) framework;
ii. using said state covariance matrix (P) to define an uncertainty tube around the predicted state trajectory; and
iii. tightening the hard mathematical constraint to ensure the entire uncertainty tube satisfies said constraint, thereby generating a rule-compliant trajectory that is robust to both sensor uncertainty and predicted sensor degradation.

56. The system of claim 55, wherein the state estimation filter is a Kalman filter, and wherein proactively reconfiguring the state estimation filter comprises dynamically increasing a value in a measurement noise covariance matrix (Rₖ) corresponding to the first sensor.

57. The system of claim 55, wherein the health monitoring and fault management module is further configured to generate the predictive fault signature using a data-driven prognostic model trained to predict a Remaining Useful Life (RUL) of the first sensor.

58. The system of claim 55, wherein the autonomous marine vessel is an Autonomous Surface Vessel (ASV), and the multi-modal sensor suite comprises at least two sensors selected from the group consisting of a radar, an Automatic Identification System (AIS) transceiver, a thermal camera, and a LiDAR.

59. The system of claim 55, wherein the intelligent decision-making module is further configured to asymmetrically shape the uncertainty tube based on a specific COLREGs encounter type identified from the data acquired from the marine environment.

60. A method for providing fail-operational control of an autonomous marine vessel, the method comprising:
a. acquiring, via a multi-modal sensor suite on the vessel, data from a marine environment, said sensor suite comprising a plurality of marine-specific sensors including a first sensor and a second sensor;
b. continuously monitoring, via a health monitoring module, a set of operational parameters of the first sensor distinct from data primarily used for navigation;
c. detecting, via the health monitoring module, an incipient fault indicative of a future functional failure of the first sensor;
d. upon detecting the incipient fault, generating, via the health monitoring module, a predictive fault signature;
e. generating, via an adaptive hybrid sensor fusion module, a vessel state estimate and a state covariance matrix (P) representing an uncertainty of the vessel state estimate, wherein the state covariance matrix (P) is increased in response to the predictive fault signature;
f. generating a navigational plan in compliance with the International Regulations for Preventing Collisions at Sea (COLREGs) by:
i. translating a COLREGs rule into a hard mathematical constraint within a Model Predictive Control (MPC) framework;
ii. propagating said state covariance matrix (P) over a prediction horizon to define an uncertainty tube around a nominal predicted trajectory; and
iii. tightening the hard mathematical constraint to ensure the entire uncertainty tube remains compliant with said constraint.

61. The method of claim 60, wherein the state estimation filter is a Kalman filter, and wherein the state covariance matrix (P) is increased by dynamically increasing a value in a measurement noise covariance matrix (Rₖ) corresponding to the first sensor.

62. The method of claim 60, further comprising asymmetrically shaping the uncertainty tube based on a specific COLREGs encounter type identified from the acquired data.

63. A fail-safe robotic system, comprising:
a. a robotic manipulator;
b. a control and actuation module configured to control the robotic manipulator;
c. a health monitoring module configured to:
i. monitor a health status of a component of the system to detect an incipient fault;
ii. upon detecting the incipient fault, generate a fault signature comprising at least an anomaly-severity value(s) and an estimated time-to-failure (τ); and
d. an intelligent decision-making module configured to, in response to receiving said fault signature, command the control and actuation module to execute a predefined fail-safe protocol to place the robotic manipulator in a safe state, wherein the predefined fail-safe protocol is selected based on the anomaly-severity value(s) and the estimated time-to-failure (τ).

64. The system of claim 63, wherein the health monitoring module is configured to estimate the time-to-failure (τ) using a recurrent neural network trained on historical sensor data.

65. The system of claim 63, wherein the robotic system is a surgical robot, and the predefined fail-safe protocol is selected from the group consisting of an automatic retraction of a surgical instrument coupled to the manipulator along a safe path, and an immediate application of force limiting to the manipulator to prevent unintended force application.

66. The system of claim 65, wherein the control and actuation module comprises redundant hardware selected from the group consisting of redundant manipulators, redundant actuators, and redundant power supplies.

67. The system of claim 63, wherein the robotic system is a collaborative robot configured to operate in a shared workspace with a human, and wherein a multi-modal sensor suite is configured to monitor the workspace to determine a position and a motion of the human.

68. The system of claim 67, wherein the intelligent decision-making module is further configured to:
a. predict a future motion of the human based on data from the sensor suite using an artificial intelligence algorithm; and
b. proactively adapt a speed or a path of the robotic manipulator to maintain a safe separation from the human's predicted future motion.

69. The system of claim 68, wherein the multi-modal sensor suite further comprises redundant force/torque sensors coupled to the robotic manipulator, and wherein the intelligent decision-making module is further configured to execute a fail-safe protocol comprising an immediate stop of the robotic manipulator upon detection of an unintended contact by said force/torque sensors.

70. A method for providing fail-safe control of a robotic system, the method comprising:
a. controlling, via a control and actuation module, a robotic manipulator;
b. continuously monitoring, via a health monitoring module, a health status of a component for an incipient fault;
c. upon detecting said incipient fault, generating, via the health monitoring module, a fault signature comprising at least an anomaly-severity value(s) and an estimated time-to-failure (τ); and
d. in response to generating the fault signature, executing, via an intelligent decision-making module, a predefined fail-safe protocol selected based on the anomaly-severity value(s) and the estimated time-to-failure (τ).

71. The method of claim 70, wherein the robotic system is a surgical robot, and wherein executing the predefined fail-safe protocol comprises selecting an action from the group consisting of an automatic retraction of a surgical instrument to a safe position and an application of precise force limiting to prevent unintended force on tissue.

72. The method of claim 70, wherein the robotic system is a collaborative robot operating in a shared workspace with a human, the method further comprising:
a. predicting, via an artificial intelligence algorithm, a future motion of the human;
b. proactively adapting a speed or a path of the collaborative robot to maintain a safe separation from the human's predicted future motion; and
c. executing a fail-safe protocol comprising an immediate stop of the collaborative robot in the event of an unintended contact detected by a redundant force/torque sensor.

73. A method for prognostic management of a critical system, the method comprising:
a. receiving, via a data acquisition interface, a continuous stream of time-series operational data from a critical component of an external apparatus;
b. processing, via a prognostic processing unit, the time-series operational data using a deep learning prognostic model to generate an estimated time-to-failure (τ) for the critical component;
c. defining a planned mission duration (D) for a next operational mission of the external apparatus;
d. calculating, via a mission management processor, a prognostic health score by comparing the estimated time-to-failure (τ) against the planned mission duration (D); and
e. in response to the prognostic health score indicating that τ<D, automatically generating an advisory command to modify an operational readiness status of the external apparatus, wherein the advisory command is provided to an operator or an external control system to govern the commencement of the next operational mission.

74. The method of claim 73, wherein the deep learning prognostic model is a Recurrent Neural Network (RNN) or a Long Short-Term Memory (LSTM) network trained on run-to-failure data from similar critical components.

75. The method of claim 73, wherein the external apparatus is a surgical robot, and the critical component is a joint actuator or an encoder.

76. The method of claim 73, wherein the advisory command comprises a command to postpone the next operational mission.

77. A Prognostic Health Management (PHM) system for critical systems, comprising:
a. a memory storing executable instructions;
b. a data acquisition interface configured to continuously receive time-series operational data from a critical component of an external apparatus;
c. a prognostic processing unit comprising at least one specialized processor and a deep learning prognostic model, the prognostic processing unit configured to generate an estimated time-to-failure (τ) for the critical component based on the time-series operational data; and
d. a mission management processor configured to, in response to a decrease in the estimated time-to-failure (τ) during an ongoing mission, automatically transmit a mission modification command to the external apparatus to dynamically adjust an operational constraint of the external apparatus.

78. The system of claim 77, wherein the external apparatus is a robotic manipulator comprising a control module, and the mission modification command is a signal instructing the control module to dynamically tighten the allowable velocity or acceleration bounds of the manipulator.

79. The system of claim 77, wherein the mission management processor is further configured to transmit a logistics trigger command to an external enterprise resource planning (ERP) system to initiate procurement of a replacement part when the estimated time-to-failure (τ) falls below a predefined logistics threshold.

80. A system for generating an immutable, evidentiary audit trail for a regulated external apparatus, the system comprising:
a. a data capture interface configured to monitor and capture a sequence of critical operational events generated by a control module of the external apparatus, wherein each critical operational event is a physical control action, a sensor data acquisition, or a system state transition;
b. a memory storing a predefined data structure for a log entry, the data structure including fields for (i) an event description, (ii) a precise timestamp, and (iii) a previous hash reference;
c. a cryptographic processing unit comprising at least one dedicated processor configured to execute a hashing algorithm; and
d. a secure WORM (Write-Once, Read-Many) memory component communicatively coupled to the cryptographic processing unit; wherein the cryptographic processing unit is configured to:
i. receive the sequence of operational events from the data capture interface;
ii. sequentially calculate an event hash for each captured event by applying the hashing algorithm to the log entry, wherein the log entry includes the previous hash reference linking to the event hash of the immediately preceding event;
iii. digitally sign the log entry using a private cryptographic key to guarantee non-repudiation; and
iv. transmit the digitally signed and chained log entry to the secure WORM memory component for storage, thereby creating an unmodifiable, time-stamped audit trail that demonstrates regulatory compliance.

81. The system of claim 80, wherein the external apparatus is a surgical robot, and the critical operational events include surgical tool movement commands and manipulator force readings.

82. The system of claim 80, wherein the hashing algorithm is SHA-256.

83. The system of claim 80, wherein the cryptographic processing unit is further configured to encrypt the log entry prior to storage in the secure WORM memory component to maintain confidentiality of Electronic Protected Health Information (ePHI).

84. A method for creating a verifiable, immutable audit trail for a high-reliability external apparatus, the method comprising:
a. monitoring, via a data capture interface, a sequence of operational events, including control commands issued to or sensor data received from the external apparatus;
b. formatting, via a cryptographic processing unit, the operational events into a log entry data structure that includes a field referencing a hash of an immediately preceding log entry;
c. calculating, via the cryptographic processing unit, a cryptographic hash of the formatted log entry;
d. digitally signing, via the cryptographic processing unit, the log entry using a private key unique to the system to ensure source non-repudiation; and
e. storing the digitally signed log entry in a Write-Once, Read-Many (WORM) compliant memory configured to prevent modification or deletion, thereby establishing a technically secure, evidentiary record satisfying regulatory audit requirements.

85. The method of claim 84, wherein the external apparatus is a medical device, and wherein the immutable audit trail is used to demonstrate compliance with 21 CFR Part 11.

86. The method of claim 84, further comprising enforcing a Role-Based Access Control (RBAC) policy for viewing the stored log entries, wherein only authorized personnel are granted viewing permissions.

87. A system for autonomous environmental and wildlife conservation, comprising:
a. an autonomous vehicle;
b. a multi-modal sensor suite disposed on the autonomous vehicle, the suite comprising at least a thermal sensor configured to acquire thermal data and a Light Detection and Ranging (LiDAR) sensor configured to acquire a three-dimensional (3D) point cloud of an environment; and
c. a processing system communicatively coupled to the multi-modal sensor suite, the processing system configured to:
i. apply a semantic segmentation algorithm to the 3D point cloud to identify an object cluster by computationally distinguishing the object cluster from environmental features;
ii. validate a geometric structure of the object cluster by fitting a set of geometric primitives to the object cluster and comparing the set of geometric primitives to a stored morphological template corresponding to a biological form; and
iii. classify the object cluster as a camouflaged animal by correlating the validated geometric structure with a spatially co-located thermal signature identified from the thermal data.

88. The system of claim 87, wherein the autonomous vehicle is an unmanned aerial vehicle (UAV).

89. The system of claim 87, wherein the processing system is configured to fit the set of geometric primitives to the object cluster using a Random Sample Consensus (RANSAC) algorithm.

90. The system of claim 87, further comprising a prognostics and health management (PHM) system configured to generate a prognostic estimate of a remaining useful life (RUL) of a component of the autonomous vehicle, and wherein the processing system is further configured to autonomously modify a mission parameter of the autonomous vehicle during a conservation mission based on the prognostic estimate of the RUL.

91. The system of claim 90, wherein the component is a motor, and wherein the mission parameter is a maximum flight speed of the autonomous vehicle.

92. A method for autonomous environmental and wildlife conservation, the method comprising:
a. acquiring, via a thermal sensor on an autonomous vehicle, thermal data from an environment;
b. acquiring, via a Light Detection and Ranging (LiDAR) sensor on the autonomous vehicle, a three-dimensional (3D) point cloud of the environment;
c. applying, via a processing system, a semantic segmentation algorithm to the 3D point cloud to identify an object cluster;
d. validating, via the processing system, a geometric structure of the object cluster by fitting a set of geometric primitives to the object cluster and comparing the set of geometric primitives to a stored morphological template corresponding to a biological form; and
e. classifying the object cluster as a camouflaged animal by correlating the validated geometric structure with a spatially co-located thermal signature identified from the thermal data.

93. The method of claim 92, wherein validating the geometric structure comprises fitting the set of geometric primitives using a Random Sample Consensus (RANSAC) algorithm.

94. The method of claim 92, further comprising, for an anti-poaching surveillance mission:
a. generating, via a prognostics and health management system and a prognostic estimate of a remaining useful life (RUL) of a component of the autonomous vehicle; and
b. autonomously modifying a flight path of the autonomous vehicle based on the prognostic estimate of the RUL to ensure mission continuity.

95. A system for multi-threat management in an autonomous vehicle, comprising:
a. a multi-modal sensor suite comprising a plurality of heterogeneous sensors configured to acquire data from an operational environment;
b. a sensor fusion module configured to process said heterogeneous data into a coherent model of the operational environment, said model including a plurality of potential threats belonging to at least a first threat category and a second, different threat category;
c. a health monitoring module configured to generate a prognostic estimate of a remaining useful life (RUL) of a component of the autonomous vehicle; and
d. an intelligent decision-making module configured to, in an unavoidable collision scenario:
i. classify the plurality of potential threats based on a predefined vulnerability hierarchy;
ii. formulate a multi-objective optimization problem to determine a mitigation action, wherein a cost function of the optimization problem is weighted based on said vulnerability hierarchy to minimize ethically-weighted harm;
iii. incorporate said RUL estimate as a constraint or weighting factor in the multi-objective optimization problem to ensure the mitigation action is achievable within safe operational limits of the component; and
iv. generate a command for the autonomous vehicle to execute the mitigation action.

96. The system of claim 95, wherein the autonomous vehicle is an unmanned aerial vehicle (UAV), the first threat category is other aircraft, and the second threat category is avian hazards.

97. The system of claim 96, wherein the multi-modal sensor suite comprises ADS-B receivers and radar for detecting other aircraft, and comprises a LIDAR sensor and micro-doppler radar for detecting avian hazards.

98. The system of claim 95, wherein the predefined vulnerability hierarchy prioritizes humans over animals, and animals over property.

99. The system of claim 95, wherein a method for multi-threat management in an autonomous vehicle, the method comprising:
a. acquiring, via a multi-modal sensor suite, heterogeneous data from an operational environment;
b. processing, via a sensor fusion module, said heterogeneous data to identify a plurality of potential threats belonging to at least a first threat category and a second, different threat category;
c. receiving, from a health monitoring module, a prognostic estimate of a remaining useful life (RUL) of a component of the autonomous vehicle;
d. classifying the potential threats based on a predefined vulnerability hierarchy wherein humans are prioritized over property;
e. formulating and solving, via an intelligent decision-making module, a multi-objective optimization problem to determine a mitigation action, wherein a cost function of the optimization problem is weighted by said vulnerability hierarchy to minimize ethically-weighted harm, and wherein said RUL estimate is incorporated as a constraint in the multi-objective optimization problem; and
f. generating a command to execute the mitigation action.

100. The method of claim 99, wherein the predefined vulnerability hierarchy prioritizes humans over animals, and animals over property.

101. A method for generating a trajectory for an autonomous vehicle, the method comprising:
a. modeling, via a processor, a decision-making problem as a Markov Decision Process (MDP);
b. defining, via the processor, a state space for the autonomous vehicle, said state space comprising the vehicle's position, velocity, and a prognostic health status of at least one system component, wherein the prognostic health status includes an estimated Remaining Useful Life (RUL);
c. defining, via the processor, an action space comprising a set of vehicle maneuvers; and
d. learning, via the processor, an optimal policy for the autonomous vehicle by maximizing a multi-objective reward function, wherein the multi-objective reward function is a weighted sum of a plurality of terms including at least:
i. a safety objective based on penalties for proximity to obstacles;
ii. an efficiency objective based on rewards for progress toward a goal; and
iii. a health preservation objective based on penalties for actions that induce stress on the at least one system component when its estimated RUL is below a predefined threshold.

102. The method of claim 101, wherein the optimal policy is learned using a Proximal Policy Optimization (PPO) algorithm.

103. A method for generating a trajectory for an autonomous vehicle, the method comprising:
a. repeatedly solving, via a processor, a finite-horizon optimal control problem to determine an optimal sequence of control actions;
b. wherein the optimal control problem is defined by a prediction model used to predict future states of the vehicle over a prediction horizon;
c. wherein the optimal sequence of control actions is determined by minimizing a cost function that penalizes deviations from a reference trajectory; and
d. wherein the minimization is subject to a plurality of dynamic constraints, said dynamic constraints including at least one vehicle operational limit that is adjusted in real-time based on a prognostic estimate of a remaining useful life (RUL) of a corresponding vehicle component.

104. A method for generating a trajectory for an autonomous vehicle, the method comprising:
a. modeling, via a processor, an operational environment as a graph, wherein nodes of the graph represent discrete states and edges of the graph represent feasible transitions between states;
b. assigning, via the processor, a cost to each edge in the graph, wherein said cost is a function of a plurality of variables including at least:
i. a travel distance associated with the transition;
ii. an estimated energy consumption for the transition; and
iii. a predicted health degradation cost for the transition, calculated based on a prognostic health status of the vehicle; and
c. finding an optimal path through the graph from a start node to a goal node using an A* search algorithm that minimizes a cumulative cost based on the costs assigned to the edges.

105. A system for generating a trajectory for an autonomous vehicle, comprising a processor and a memory storing instructions that, when executed by the processor, cause the system to:
a. model a decision-making problem as a Markov Decision Process (MDP);
b. define a state space for the autonomous vehicle, said state space comprising the vehicle's position, velocity, and a prognostic health status of at least one system component, wherein the prognostic health status includes an estimated Remaining Useful Life (RUL);
c. define an action space comprising a set of vehicle maneuvers; and
d. learn an optimal policy for the autonomous vehicle by maximizing a multi-objective reward function, wherein the multi-objective reward function is a weighted sum of a plurality of terms including at least:
i. a safety objective based on penalties for proximity to obstacles;
ii. an efficiency objective based on rewards for progress toward a goal; and
iii. a health preservation objective based on penalties for actions that induce stress on the at least one system component when its estimated RUL is below a predefined threshold.

106. A system for generating a trajectory for an autonomous vehicle, comprising a processor and a memory storing instructions that, when executed by the processor, cause the system to:
a. repeatedly solve a finite-horizon optimal control problem to determine an optimal sequence of control actions;
i. wherein the optimal control problem is defined by a prediction model used to predict future states of the vehicle over a prediction horizon;
ii. wherein the optimal sequence of control actions is determined by minimizing a cost function that penalizes deviations from a reference trajectory; and
iii. wherein the minimization is subject to a plurality of dynamic constraints, said dynamic constraints including at least one vehicle operational limit that is adjusted in real-time based on a prognostic estimate of a remaining useful life (RUL) of a corresponding vehicle component.

107. A system for generating a trajectory for an autonomous vehicle, comprising a processor and a memory storing instructions that, when executed by the processor, cause the system to:
a. model an operational environment as a graph, wherein nodes of the graph represent discrete states and edges of the graph represent feasible transitions between states;
b. assign a cost to each edge in the graph, wherein said cost is a function of a plurality of variables including at least:
i. a travel distance associated with the transition;
ii. an estimated energy consumption for the transition; and
iii. a predicted health degradation cost for the transition, calculated based on a prognostic health status of the vehicle; and
c. find an optimal path through the graph from a start node to a goal node using an A* search algorithm that minimizes a cumulative cost based on the costs assigned to the edges.

108. A fail-safe system for robotic handling of hazardous materials, comprising:
a. a robotic platform having at least a first manipulator and a second, redundant manipulator;
b. a multi-modal sensor suite disposed on the robotic platform, the suite comprising at least one hazard detection sensor;
c. a prognostics and health management (PHM) module configured to continuously monitor a health status of components of the system and to generate a prognostic estimate of a remaining useful life (RUL) for at least a first component; and
d. an intelligent decision-making module communicatively coupled to the PHM module and the sensor suite, the decision-making module configured to, in response to detecting a fault, autonomously execute a predefined mitigation protocol, wherein said protocol comprises:
i. generating a new path to a predefined safe containment zone by solving a multi-objective optimization problem, wherein a cost function of said problem is a function of at least the prognostic estimate of the RUL and data from the at least one hazard detection sensor; and
ii. commanding the robotic platform to traverse said new path.

109. The system of claim 108, wherein the at least one hazard detection sensor is selected from the group consisting of a chemical sensor, a radiation detector, and a thermal camera.

110. The system of claim 108, wherein the fault is a fault in the first manipulator, and wherein the predefined mitigation protocol further comprises commanding the second, redundant manipulator to secure a hazardous material payload being handled by the first manipulator.

111. The system of claim 110, wherein the first and second manipulators are equipped with redundant force/torque sensors, and wherein commanding the second, redundant manipulator comprises executing a load-balancing algorithm based on feedback from said force/torque sensors.

112. The system of claim 108, wherein the cost function of the multi-objective optimization problem is a weighted sum of a plurality of terms including a predicted health degradation cost based on the prognostic estimate of the RUL.

113. The system of claim 112, wherein the plurality of terms further includes a hazard exposure cost based on data from the hazard detection sensor and a payload stability cost based on a geometric characteristic of the new path.

114. A method for providing fail-safe control of a robot handling a hazardous material, the method comprising:
a. continuously monitoring, via a prognostics and health management (PHM) module, a health status of components of the robot to generate a prognostic estimate of a remaining useful life (RUL) for at least a first component, the robot having at least a first manipulator and a second, redundant manipulator;
b. continuously monitoring, via a hazard detection sensor, an environment around the hazardous material for a containment breach;
c. upon detecting a fault or a containment breach, autonomously initiating, via an intelligent decision-making module, a predefined mitigation protocol; and
d. executing the predefined mitigation protocol, wherein said execution comprises generating a new path to a predefined safe containment zone by solving a multi-objective optimization problem, wherein a cost function of said problem is a function of at least the prognostic estimate of the RUL and data from the hazard detection sensor.

115. The method of claim 114, wherein the fault is an incipient fault in the first manipulator, and wherein executing the predefined mitigation protocol further comprises commanding the second, redundant manipulator to secure a payload held by the first manipulator based on feedback from force/torque sensors.

116. The method of claim 114, wherein solving the multi-objective optimization problem comprises finding a path that minimizes a weighted sum of a plurality of cost terms, said cost terms including a predicted health degradation cost based on the prognostic estimate of the RUL and a hazard exposure cost based on data from the hazard detection sensor.

117. A resilient autonomous system for infrastructure inspection, comprising:
a. an autonomous vehicle;
b. a multi-modal sensor suite disposed on the vehicle;
c. a prognostics and health management (PHM) module configured to continuously monitor a health status of components of the autonomous vehicle and to generate a prognostic estimate of a remaining useful life (RUL) for at least a first component; and
d. an intelligent decision-making module communicatively coupled to the PHM module, the decision-making module configured to, in response to detecting a fault in the first component, autonomously execute a mitigation protocol, wherein said protocol comprises:
i. generating a new path to a predefined safe zone by solving a multi-objective optimization problem, wherein a cost function of said problem is a function of at least the prognostic estimate of the RUL and a public safety risk cost based on the vehicle's position relative to populated areas; and
ii. commanding the autonomous vehicle to traverse said new path.

118. The system of claim 117, wherein the autonomous vehicle is an unmanned aerial vehicle (UAV) or an autonomous ground vehicle (AGV).

119. The system of claim 117, wherein the multi-modal sensor suite comprises at least one defect detection sensor selected from the group consisting of a high-resolution camera, a LiDAR sensor, an ultrasonic sensor, and a thermal imager.

120. The system of claim 119, further comprising an artificial intelligence (AI) module configured to identify an infrastructure defect by applying a semantic segmentation algorithm to a 3D point cloud from the LiDAR sensor to identify an object cluster, and correlating a geometric characteristic of the object cluster with data from the thermal imager or the ultrasonic sensor.

121. The system of claim 117, further comprising a high-precision localization module configured to provide a navigation solution in a GPS-denied environment by fusing data from a Real-Time Kinematic GPS (RTK-GPS) receiver and a LiDAR-based Simultaneous Localization and Mapping (SLAM) algorithm.

122. A method for resilient autonomous inspection of critical infrastructure, the method comprising:
a. acquiring, via a multi-modal sensor suite on an autonomous vehicle, heterogeneous data from an infrastructure asset and its environment;
b. continuously monitoring, via a prognostics and health management (PHM) module, a health status of components of the autonomous vehicle to generate a prognostic estimate of a remaining useful life (RUL) for at least a first component;
c. upon detecting a fault in the first component, autonomously initiating, via an intelligent decision-making module, a mitigation protocol; and
d. executing the mitigation protocol, wherein said execution comprises generating a new path to a predefined safe zone by solving a multi-objective optimization problem, wherein a cost function of said problem is a function of at least the prognostic estimate of the RUL and a public safety risk cost based on the vehicle's position relative to populated areas.

123. The method of claim 122, further comprising identifying a specific infrastructure defect by applying a semantic segmentation algorithm to a 3D point cloud from a LIDAR sensor to identify an object cluster, and correlating a geometric characteristic of the object cluster with data from a thermal imager to identify delamination.

124. The method of claim 122, wherein the autonomous vehicle is a UAV, and wherein detecting a fault comprises detecting an incipient fault in a motor, and wherein executing the mitigation protocol comprises reconfiguring a flight control algorithm to maintain stability using remaining healthy motors while traversing the new path.

125. A system for fail-operational control of an autonomous vehicle, the vehicle comprising a plurality of components, the system comprising:
a. a plurality of telemetry sensors, each configured to generate a telemetry data stream indicative of an operational state of at least one of the plurality of components; and
b. a processing system communicatively coupled to the plurality of telemetry sensors, the processing system configured to:
i. generate, using a data-driven predictive model, a first prognostic estimate of a remaining useful life (RUL) of a first component of the plurality of components based on the telemetry data stream associated with the first component;
ii. generate, using a physics-of-failure model, a second prognostic estimate of a degradation state of the first component;
iii. fuse the first and second prognostic estimates using a Kalman filter to produce a final, fused prognostic estimate of the RUL; and
iv. autonomously modify a mission parameter of the autonomous vehicle based on the final, fused prognostic estimate of the RUL.

126. The system of claim 125, wherein the data-driven predictive model is a Long Short-Term Memory (LSTM) network.

127. The system of claim 125, wherein the Kalman filter is an Unscented Kalman Filter (UKF).

128. The system of claim 127, wherein the processing system is configured to fuse the estimates by using the physics-of-failure model as a state transition function in a prediction step of the UKF and using the first prognostic estimate from the data-driven model as a measurement in an update step of the UKF.

129. The system of claim 125, wherein the first component is a motor, and wherein the mission parameter is a maximum flight speed of the autonomous vehicle.

130. The system of claim 125, wherein the autonomous vehicle further comprises a backup component for the first component, and wherein the processing system is further configured to command a preemptive switch from the first component to the backup component based on the final, fused prognostic estimate of the RUL falling below a predefined threshold.

131. A method for fail-operational control of an autonomous vehicle, the vehicle comprising a plurality of components, the method comprising:
a. generating, via a plurality of telemetry sensors, a telemetry data stream for each of a plurality of components;
b. generating, via a processing system using a data-driven predictive model, a first prognostic estimate of a remaining useful life (RUL) of a first component based on the telemetry data stream associated with the first component;
c. generating, via the processing system using a physics-of-failure model, a second prognostic estimate of a degradation state of the first component;
d. fusing, via the processing system, the first and second prognostic estimates using a Kalman filter to produce a final, fused prognostic estimate of the RUL; and
e. autonomously modifying, via the processing system, a mission parameter of the autonomous vehicle based on the final, fused prognostic estimate of the RUL.

132. The method of claim 131, wherein the data-driven predictive model is a Long Short-Term Memory (LSTM) network and the Kalman filter is an Unscented Kalman Filter (UKF).

133. The method of claim 132, wherein fusing the estimates comprises using the physics-of-failure model as a state transition function in a prediction step of the UKF and using the first prognostic estimate from the LSTM network as a measurement in an update step of the UKF.

134. The method of claim 131, further comprising:
a. calculating a cumulative mission risk score based on final, fused prognostic estimates of RUL for the plurality of components; and
b. commanding the autonomous vehicle to execute a return-to-base protocol when the cumulative mission risk score exceeds a safety threshold.

135. A system for autonomous object detection, comprising:
a. a multi-modal sensor suite, the suite comprising at least a thermal sensor configured to acquire a two-dimensional (2D) thermal image of an environment and a Light Detection and Ranging (LiDAR) sensor configured to acquire a three-dimensional (3D) point cloud of the environment; and
b. a processing system communicatively coupled to the multi-modal sensor suite, the processing system configured to:
i. apply a semantic segmentation algorithm to the 3D point cloud to identify an object cluster by assigning class labels to points in the 3D point cloud and grouping a set of contiguous points not labeled as background or environmental features;
ii. validate a geometric structure of the object cluster by fitting a set of geometric primitives to the object cluster and comparing the set of geometric primitives and their spatial relationships to a stored morphological template, wherein the morphological template comprises a structured model defining a plurality of primitive types and their required spatial relationships; and
iii. classify the object cluster as a target of interest only when the geometric structure is validated and a co-located thermal signature is confirmed, wherein confirming the co-located thermal signature comprises: (1) projecting the set of fitted geometric primitives from a 3D coordinate system of the point cloud into a 2D coordinate system of the thermal image to define a geometric mask; and (2) calculating an aggregate thermal intensity value for only the pixels of the thermal image falling within said geometric mask to determine a presence of the thermal signature.

136. The system of claim 135, wherein the system is disposed on an autonomous vehicle.

137. The system of claim 136, wherein the autonomous vehicle is an unmanned aerial vehicle (UAV).

138. The system of claim 135, wherein the processing system is configured to fit the set of geometric primitives to the object cluster using a Random Sample Consensus (RANSAC) algorithm.

139. The system of claim 135, wherein the stored morphological template corresponds to a biological form.

140. The system of claim 139, wherein the biological form is a quadruped or a bipedal form, and wherein the structured model defines a torso primitive and a plurality of limb primitives with required spatial connections to the torso primitive.

141. The system of claim 135, wherein the multi-modal sensor suite further comprises an acoustic sensor, and wherein the processing system is further configured to refine the classification of the target of interest by correlating the classification with a species-specific vocalization detected by the acoustic sensor.

142. A method for autonomous object detection, the method comprising:
a. acquiring, via a thermal sensor, a two-dimensional (2D) thermal image of an environment;
b. acquiring, via a Light Detection and Ranging (LiDAR) sensor, a three-dimensional (3D) point cloud of the environment;
c. applying, via a processing system, a semantic segmentation algorithm to the 3D point cloud to identify an object cluster by assigning class labels to points in the 3D point cloud and grouping a set of contiguous points not labeled as background or environmental features;
d. validating, via the processing system, a geometric structure of the object cluster by fitting a set of geometric primitives to the object cluster and comparing the set of geometric primitives and their spatial relationships to a stored morphological template, wherein the morphological template comprises a structured model defining a plurality of primitive types and their required spatial relationships; and
e. classifying, via the processing system, the object cluster as a target of interest only when the geometric structure is validated and a co-located thermal signature is confirmed, wherein confirming the co-located thermal signature comprises:
i. projecting the set of fitted geometric primitives from a 3D coordinate system of the point cloud into a 2D coordinate system of the thermal image to define a geometric mask; and
ii. calculating an aggregate thermal intensity value for only the pixels of the thermal image falling within said geometric mask to determine a presence of the thermal signature.

143. The method of claim 142, wherein validating the geometric structure comprises fitting the set of geometric primitives using a Random Sample Consensus (RANSAC) algorithm.

144. The method of claim 142, wherein the stored morphological template corresponds to a biological form.

145. The method of claim 144, wherein the biological form is a quadruped or a bipedal form, and wherein the structured model defines a torso primitive and a plurality of limb primitives with required spatial connections to the torso primitive.

146. The method of claim 142, further comprising:
a. acquiring, via an acoustic sensor, acoustic data from the environment; and
b. refining the classification of the target of interest by correlating the classification with a species-specific vocalization detected in the acoustic data.
